(19) United States
(12) Patent Application Publication
(10) Pub. No.: US 2012/0193907 A1
(43) Pub. Date: Aug. 2, 2012

(54) PIPE COUPLING COVER

(76) Inventor: Nils Mittet Skarbövig, Vredenburg (ZA)

(21) Appl. No.: 13/498,257

(22) PCT Filed: Nov. 11, 2009
(86) PCT No.: PCT/IB09/07411

§ 371 Date: Apr. 13, 2012

(30) Foreign Application Priority Data
Sep. 28, 2009 (ZA) 2009/06726

(51) Int. Cl. F16L 58/18

(52) U.S. Cl. 285/45

(57) ABSTRACT

A cover is provided for a pipe coupling (1) wherein the cover has a first part (2) in the form of an impervious collection chamber adapted to cover approximately one circumferential half of a pipe coupling. The collection chamber is defined by a pair of spaced generally parallel flexible side walls (3, 41) and a peripheral wall (4) that preferably includes a transparent zone interconnecting corresponding radially outer edges of the side walls to form the collection chamber. Free edges of the walls that form an opening communicating with the collection chamber have deep generally semi [symbol] circular recesses (5) for accommodating one half of the circumference of a pipe (6) adjacent a coupling in use. A co-operant second part (9) of the cover serves as a retainer for the first part, in use. The second part has similar side walls (11) and at least one interconnecting peripheral wall (12) with recesses in free edges of the side walls for accommodating an opposite half of the circumference of a pipe adjacent a coupling in use. Each of the recesses has a lateral collar (7, 13, 33, 40) extending around its periphery. Means are provided for holding the collars around the outer surface of a pipe in use.

### FIELD OF THE INVENTION

This invention relates to a pipe coupling cover that is particularly well-suited to use in covering submerged pipe couplings such as the commonly used bolted flanges or other couplings, especially, but not exclusively, in relation to undersea oil and gas pipelines.

### BACKGROUND TO THE INVENTION

A wide range of bulk liquids and gases is conveyed trough pipelines in all parts of the world. Pipelines are extensively used in manufacturing plants and mines; in urban environments to distribute water and gas. They are also used to convey vast quantities of crude oil, natural gas, fuel, chemicals, and water over long distances, often thousands of kilometres, with the pie being located above ground, underground, and, in particular, under water.

Most pipelines, regardless of their size or function, use mechanical couplings between joined pipe sections and between pipe sections and various structural or control elements, such as bends, junctions, valves and take-offs. Pipe couplings, commonly in the form of bolted flanges, allow the assembly of pipeline components and their subsequent dismantling for servicing, repair or modification.

Pipe couplings normally include seals to prevent leakage of the conveyed fluid. The higher the pumping pressure of the fluid, the more sensitive the couplings and seals become to relative movement of the pipeline in service and the more likely they are to leak. Some movement of a pipeline is inevitable and therefore routine checking and maintenance of pipe couplings is essential to avoid leakage with its accompanying wastage and pollution as well as pressure loss in the pipeline. Pipeline couplings accordingly need also to be protected against corrosion and fouling, particularly in aggressive environments and difficult to get to locations.

Underwater oil and gas pipelines are amongst the most important in this regard as they are typically subjected to undersea currents, seawater corrosion, and marine fouling including trawler and other fishing net entanglement. Such pipelines are very expensive to access for inspection and maintenance purposes and contribute significantly to a pressing need for diminishing marine fouling and facilitating inspection.

Applicant's research has revealed prior publications each of which addresses a perceived difficulty, but none addresses the combination of the difficulties that exist adequately or in sufficiently cost effective manner.

U.S. Pat. No. 4,457,517 to Dunegan describes an elastomeric pipe flange protector in the form of a ring that sealingly encircles the peripheral edges of the pipe flanges to protect the gasket between the pipe flanges. The flange protector has grease fittings whereby grease can be introduced into the gap between the pipe flanges on the outside of the gasket. No attempt is made to assist in leak detection.

U.S. Pat. No. 6,231,052 to Forlander describes a similar pipe flange protector that is transparent and also has grease fittings. The transparency of the protector enables the amount of grease within the fitting to the visually obsered and renders corrosion visible.

U.S. Pat. No. 4,403,794 to Curran et al describes a transparent safety shield for encircling the peripheral edges of pipe flanges, the safety shield consisting of a heat shrunk band that tightly encircles the pipe flange edges and overlaps the edges of the pipe flanges by a short distance in the radial direction. No attempt is made to cover the bolts used for fastening the flanges together.

U.S. Pat. No. 2,699,960 to Callery et al describes a transparent moulded plastics casing for collecting leakage from a pipe coupling with two halves being identical and having outwardly extending flanges that are interconnected by way of integral buttons and holes receiving the same in the other flange. Such a casing would be totally unsuitable for rugged conditions, especially underwater applications and especially those where movement of water such as is created by marine currents is to be tolerated. Also, the injection moulding die costs for such a casing are substantial, especially in respect of large diameter undersea types that can be up to about 1 m in diameter. Another disadvantage of this design for an underwater pipeline application is that of locating the casings in position and supporting the entire weight of the pipeline as the plastic shell will not be able to carry such a load.

U.S. Pat. No. 5,312,137 to Nee describes a safety shield for capturing corrosive fluids that may escape from a joint in a piping system and for draining the same. The safety shield has two shroud members that have outwardly directed flanges that are bolted together with a series of bolts and are sealed to each other as well as to the pipe passing through the safety shield. Typically the chamber formed within the closed shrouds has an outlet for any corrosive fluids that may have leaked from the relevant pipe joint. The chamber may also be fitted with gauges that can be used to monitor temperature or pressure or both within the safety shield.

U.S. Pat. No. 5,678,864 to Brown describes a rather large inverted U-shaped rigid safety shield for temporary location over a pipe joint to shield personnel from leaks that may emanate from a pipe joint, the safety shield serving to defect leaks so that they can run into a lower collection facility. The so-called front and back walls are of inverted U-shape as a result of the notches formed therein for receiving the pipe on each side of a joint. The lowermost edge of the safety shield can project beyond the pipe and generally rest on a support service below the pipe. The safety shield is maintained in captive association with a pipe by means of releasable straps or chains that pass underneath the pipe. A window in the top of the safety shield facilitates installation and removal of the safety shield. The safety shield is large, cumbersome and costly in addition to the fact that it cannot be allowed to remain on a pipe in bad ambient conditions especially as it is unstable against rotation about the pipe.

### OBJECT OF THE INVENTION

It is an object of this invention to provide a cover for a pipe coupling that serves one or more purposes indicated above and that is relatively inexpensive to manufacture. It is another object of the invention to provide a cover for a pipe coupling that may be of large dimensions that would necessitate a rather heavy and cumbersome cover were it to be made according to the prior art outlined above.

### SUMMARY OF THE INVENTION

In accordance with this invention there is provided a cover for a pipe coupling wherein the cover has a first part in the form of an impervious collection chamber adapted to cover approximately one circumferential half of a pipe coupling, the collection chamber being defined by a pair of spaced generally parallel side walls and a peripheral wall interconnecting corresponding radially outer edges of the side walls to form the collection chamber with free edges of the walls forming an opening communicating with the collection chamber, generally semi-circular recesses centrally located in the free edges of the side walls for accommodating one half of the circumference of a pipe adjacent a coupling in use, and a co-operant second part of the cover serving as a retainer for the first part, in use, and having side walls and at least one interconnecting peripheral wall with corresponding recesses in free edges of the side walls for accommodating an opposite half of the circumference of a pipe adjacent a coupling in use such that, in a closed position of the cover, a pipe coupling may be substantially enclosed within the cover, the cover being characterised in that the side walls are made of a generally flexible sheet material and in that a laterally extending collar extends around the periphery of each of the recesses and means are provided for holding the collars around the outer surface of a pipe in use.

Further features of the invention provide for the means for holding the collars around the outer surface of a pipe to be extension flaps at appropriate ends of the collars that can be partially overlapped with an adjacent collar of the other part of the cover and wherein means are provided for releasably securing the extension flap to the corresponding flap of the other part of the cover and wherein a separate band may be provided for engaging a collar and adjacent pipe surface with the separate band having band extensions for overlapping an adjacent zone of an adjacent collar; for any overlapping zones to be connected by releasable fasteners, especially hook and loop fasteners such as those sold under the trade name VELCRO™; for any overlapping extensions to have suitable handgrips for manipulating them under appropriate circumstances such as whilst wearing deep sea diving gloves; for the peripheral wall of the collection chamber and a peripheral wall of the co-operant second part to be connected at one end thereof by way of a hinge zone that is optionally formed integral with the peripheral walls; and for any separate bands to be likewise connected at one end thereof by way of a hinge zone that is optionally formed integral with the band and associated collar.

It is a further important feature of the invention that at least a part of one of the walls defining the collection chamber be transparent so that any fluids collected there and that are non-miscible with the ambient environment can be visually observed. The transparent part of a wall thus preferably includes a zone radially remote from the pipe axis, in use. Typically in the instance of an underwater pipeline it would be oil, other liquid of gaseous petroleum product, or natural gas being conveyed in the pipeline, in which instance the collection chamber would be located uppermost. The transparent part will typically form a window in the peripheral wall of the collection chamber or, alternatively, the entire peripheral wall of the collection chamber may be transparent. The side walls may also be transparent or include transparent windows. The transparent part may include a hollow transparent projection extending generally radially from the peripheral wall.

The invention also provides for the side walls, collars, separate bands and peripheral walls all to be made of polymer material and if they are in the form of opaque walls, they may also be reinforced with fibres, especially a suitable fabric. It is envisaged that a suitably chemically inert plastic sheet material such as a polyvinyl chloride (PVC) will be suitable for the purpose. In any event, it is preferred that individual side walls, collars, peripheral walls, and bands are cut to a required shape and are fastened together such as by welding, especially ultrasonic or high frequency welding, to join the individual components along lines of attachment to each other.

In a first variation of the invention that is suitable for use in covering a pipe coupling that is elevated relative to the ground or other support surface, the second part of the cover may be substantially similar to the first part except for the fact that the second part does not generally require any transparent areas. In such an instance the two peripheral walls can join at a hinge section and can indeed be integral with each other. In this variation it is also possible to provide the collars with seals for sealing the interior of the cover.

In a second variation of the invention that is suitable for use in covering a pipe coupling that actually rests on a flat support mat for supporting the pipe, the second part of the cover may have a removable section and the lowermost part of the side walls and peripheral wall may be cut away to provide an opening to accommodate the zone of a pipe coupling resting on the support therefor. In such an instance the removable section allows the remainder of the second part of the cover, that is to say the main section, to be located relative to a pipe coupling and the removable section may then be attached to the main section of the second part of the cover. This is conveniently done using fasteners such as hook and loop fasteners provided on overlapping portions of the removable and main sections of the second part of the cover.

It will be understood that the nature of the pipe coupling is irrelevant to the operation of the invention and in what follows, conventional bolted flanges are illustrated.

In order that the invention may be more fully understood various embodiments thereof will now be described with reference to the accompanying drawings.

### BRIEF DESCRIPTION OF THE DRAWINGS

In the drawings:—

FIG. 1 is a schematic isometric view of one embodiment of the first variation of cover according to the invention taken from an upper position with the cover in an open condition;

FIG. 2 is a similar view illustrating a pipe coupling installed relative to the second or retainer part of the cover;

FIG. 3 is a similar view illustrating the cover partially closed;

FIG. 4 is a similar view illustrating the cover fully closed;

FIG. 5 is an isometric view from a lower position showing the underneath of the cover relative to a pipe coupling with the cover in a partially open condition;

FIG. 6 is a schematic sectional elevation of the pipe coupling with the cover illustrated in FIGS. 1 to 5 installed thereon;

FIG. 7 illustrates in plan view one possible set of components cut from flexible sheet material and prior to assembly thereof to form the cover illustrated in FIGS. 1 to 6;

FIG. 8 is a view similar to FIG. 1 but illustrating a first embodiment of the second variation of the invention in which the second or lower part has a removable section;

FIG. 9 is a view similar to FIG. 5 illustrating the opening provided in the bottom of the cover illustrated in FIG. 8;

FIG. 10 is a view similar to FIG. 1 but illustrating a second embodiment of the first variation of the invention;

FIG. 11 shows the embodiment of the invention illustrated in FIG. 10 in a closed condition;

FIG. 12 is a schematic sectional elevation of the pipe coupling and cover illustrated in FIGS. 10 and 11;

FIG. 13 is a view similar to FIG. 8 but illustrating a different form of hand grip;

FIG. 14 is a view similar to FIG. 4 but illustrating a cover having no transparent window;

FIG. 15 is a view similar to FIG. 4 but illustrating a cover having a hollow transparent projection extending from the peripheral wall; and,

FIG. 16 is a schematic isometric view of a variation in which the collars are adapted to seal with respect to the surface of a pipe.

### DETAILED DESCRIPTION WITH REFERENCE TO THE DRAWINGS

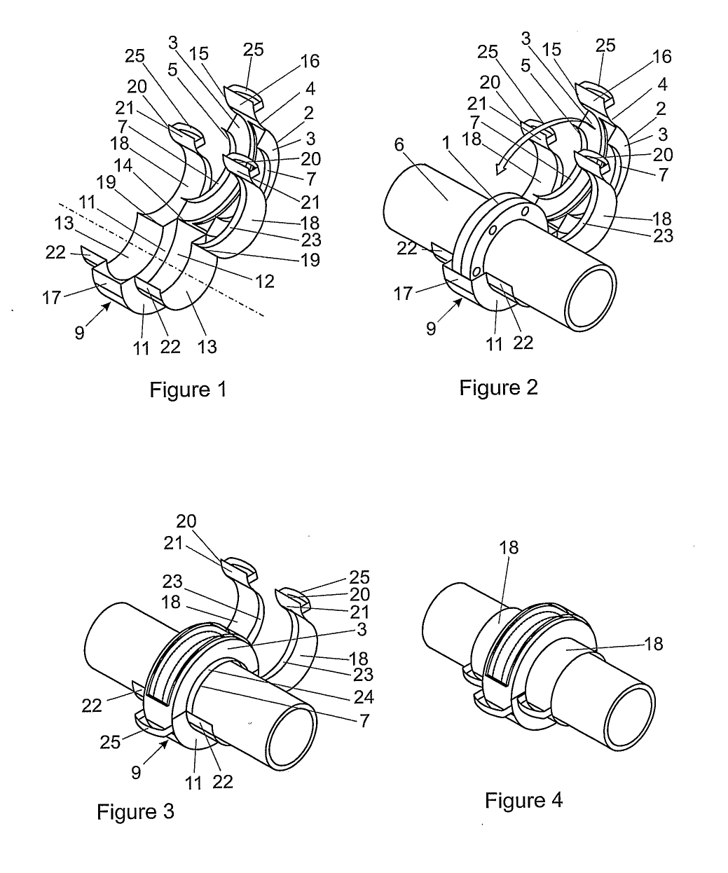

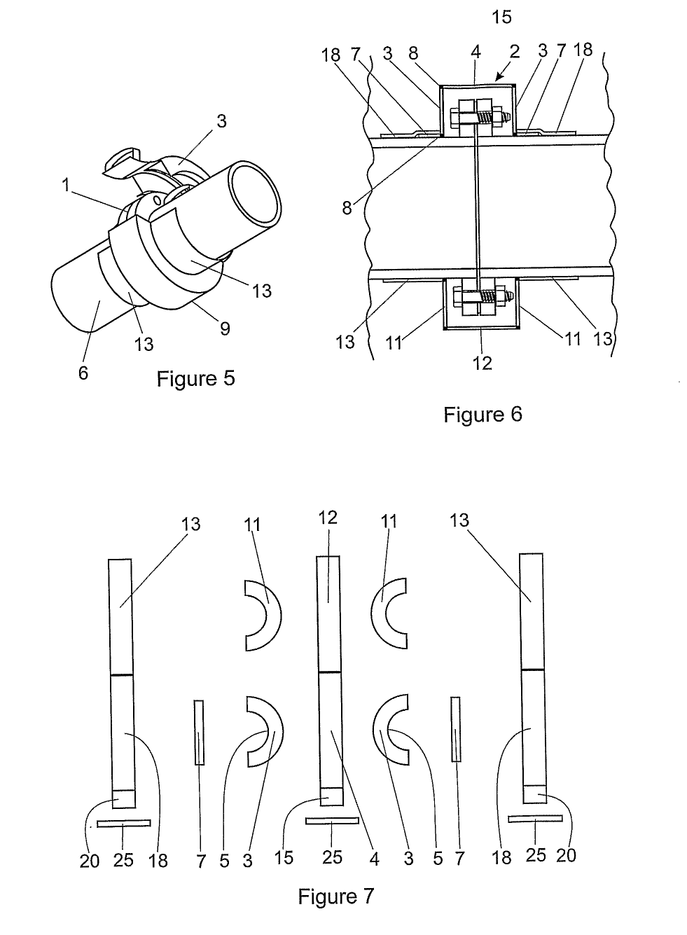

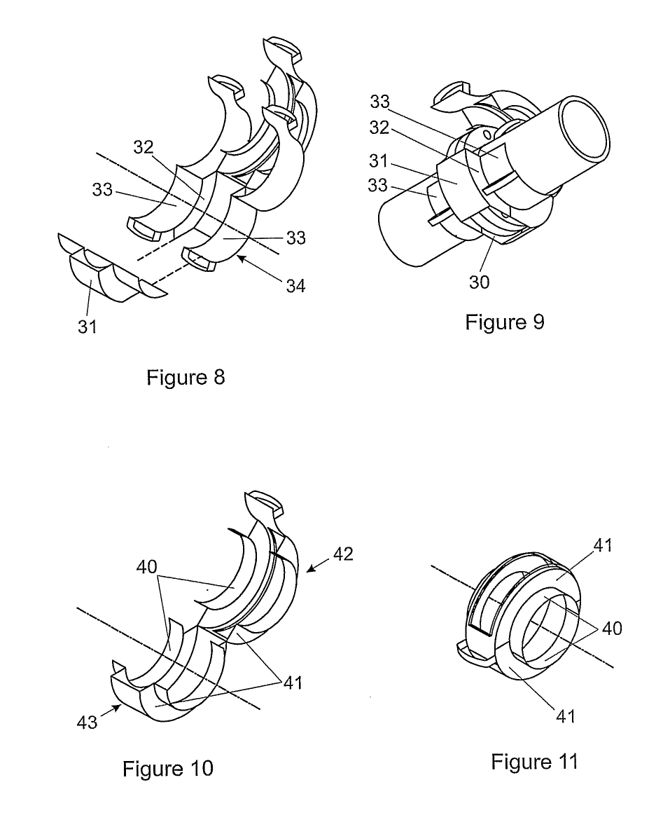

In the embodiment of the first variation of the invention illustrated in FIGS. 1 to 7 of the drawings, a cover for a pipe coupling (1) that is illustrated as being a conventional bolted flange type of coupling, but that could be of any other sort, is particularly intended for use in underwater conditions on pipelines that convey liquid petroleum, liquid or gaseous petroleum products or natural gas. As these products are all lighter than water, the cover is described as being in an orientation in which it is intended to trap rising products that may leak from the pipe coupling. In the event that the potentially leaking products were heavier than water, or the cover is used in a gaseous such as an atmospheric environment to convey liquid, then the cover would be inverted so as to catch falling leaked liquid.

The cover has a first part in the form of an uppermost impervious collection chamber (2) adapted to cover approximately one circumferential half of the pipe coupling, the collection chamber being defined by a pair of spaced generally parallel side walls (3) and a peripheral wall (4) interconnecting corresponding generally semicircular radially outer edges of the side walls. The free edges of the sidewalls and peripheral wall thus form an opening communicating with the chamber and each of the edges of the sidewalls has a deep generally semi-circular recess (5) centrally located for accommodating one half of the circumference of a pipe (6) adjacent the coupling in use. The side walls of thus semi-annular in shape.

A narrow, laterally extending collar (7) extends around the periphery of each of the recesses such that it will substantially contact the surface of the pipe, in the installed position.

In terms of this invention, the sidewalls and collars are cut from flexible sheet material, typically fabric reinforced PVC sheet material. The peripheral wall may be of a transparent PVC material or, alternatively, it may have a transparent window welded to the periphery of an aperture formed in the peripheral wall itself. In either event, the pre-cut walls are welded together as indicated by numeral (8) in FIG. 6, conveniently ultrasonically or by high frequency welding.

In this embodiment of the invention, a co-operant second part (9) of the cover that serves as a retainer for the first part, in use, is similarly constructed and has side walls (11) and an interconnecting peripheral wall (12) with corresponding recesses in the free edges of the side walls for accommodating an opposite half of the circumference of a pipe adjacent a coupling in use. The edges of the recesses have laterally extending wider collars (13) that are substantially wider than the narrow collars (7) of the collection chamber.

The peripheral wall (4) of the collection chamber (2) and the peripheral wall (12) of the second part of the cover are joined at one extremity of each through a hinged zone (14) that may be integral with the peripheral walls but might also be a separate plastics component. In the event that the two peripheral walls are integral, the hinged zone can be formed in known manner by heat forming lines of depression across the peripheral wall.

At the other extremity of the peripheral wall (4) of the collection chamber there is an extension flap (15) that has on its inside one of the mating parts (16) of a hook and loop fastener of the type sold under the trade name VELCRO™ and the other mating part (17) of the fastener system is provided on an outside of the cooperating end zone of the peripheral wall (12) of the second part of the cover.

The wider collars (13) of the second part of the cover merge with separate bands (18) at a hinge zone (19) such that each band can be engaged with one of the narrow collars (7) to urge it towards the outer surface of the pipe when it is pulled down over the collar. Each band (18) has an extension flap (20) that carries one part (21) of a hook and loop fastener system with the other part (22) being carried on the outer surface of the cooperating end of the wider collar. The parts of the hook and loop fastener system may also extend around the outside surface of the narrow collar and cooperating band as indicated by numerals (23) and (24) respectively.

Each of the extension flaps has a hand grip (25) in the form of a strip of sheet polymer material formed into a loop across the end region of the extension.

It will be understood that the width of the peripheral walls will be chosen so that the entire pipe coupling will be enclosed within the cover with the collars encircling the pipe on each side of the coupling.

In order to install a cover as described above the second part is firstly located over the lower part of the pipe coupling (1), as illustrated in FIG. 2, and thereafter the first part being the collection chamber of the cover is closed and its extension flap (15) pulled whilst simultaneously overlapping and engaging the mating parts (16) and (17) of the fastener system to hold the cover closed. The resultant position is illustrated in FIG. 3. The two bands are then pulled one after the other and engaged with the associated narrow collar (7) and their extension flaps (20) pulled and manipulated to overlap and engage the two parts (21) and (22) of the fastener system. The result of this operation is illustrated in FIG. 4. The underside of the cover is illustrated in FIG. 5.

It will be understood that the above arrangement provides an extremely secure cover that can withstand movements experienced by underwater pipelines and that totally obscures the coupling thus protecting the coupling itself and also preventing objects such as fishing nets and fishing lines from becoming entangled with the couplings or any projections associated with it. Also, this embodiment of the invention has the substantial advantage that any leakage will be trapped within the collection chamber and will be visible through the transparent zone of the peripheral wall. The cover can be easily removed for maintenance purposes and replaced as and when required. As a general rule the cover is sufficiently dimensioned to provide a loose fit around the pipe coupling including any projecting flange bolts and nuts or other fasteners. Furthermore, the covers are configured to facilitate comfortable handling with heavy protective diving gear.

As indicated above, the cover of the first variation of the invention is appropriate in instances in which the pipe coupling does not engage the support surface for the pipe or in instances in which a pipe can be lifted to allow for installation of the cover.

In numerous instances, especially in the case of underwater pipelines, the pipes are supported on their flanges or other pipe couplings. The pipes are generally too heavy to be lifted to allow for the installation of a cover as described above.

In such an instance a cover according to the second variation of the invention may be used. One embodiment of such a variation is illustrated in FIGS. 8 and 9 of the drawings. In this instance, the cover is generally the same as that described above except for the fact that the lowermost part of the side walls and peripheral wall are cut away to provide an opening (30) to accommodate the lowermost zone of a pipe coupling as it rests on a support therefor. A removable section (31) closes one circumferential end of the opening such that, as shown in FIG. 8, the spaced side walls (32) and collars (33) of the main section (34) of the second part are spaced apart and can be passed from one side of a pipeline to the other side with the pipe coupling between them. The removable section is then re-attached to the main section of the second part of the cover. This is conveniently done using mating parts of hook and loop fasteners in a manner indicated above. The remainder of the installation of such a cover is as described above.

Numerous variations may be made to the embodiments of the invention described above without departing from the scope hereof.

In particular, the means for holding the collars around the outer surface of a pipe can be varied widely. A somewhat simplified embodiment of the invention is illustrated in FIGS. 10 to 12 of the drawings. In this embodiment of the invention the bands described above in relation to the embodiment of FIGS. 1 to 7 are omitted and the collars (40) attached to the side walls (41) of both parts (42, 43) of the cover are of the same width and have circumferential extensions that overlap and are attached to each other by means of mating fasteners in the closed position.

FIG. 13 illustrates an alternative form of handgrips that may be suitable for manipulation whilst wearing diving gloves or the like, these handgrips being in the form of simple strips (45) of flexible sheet material attached, in this instance, to the collar portions of a removable section (46) of a cover as illustrated in, and described with respect to, FIGS. 8 and 9.

FIG. 14 illustrates a cover (50) for a pipe coupling that has no transparent window.

FIG. 15 illustrates a cover (55) that not only has a peripheral wall in the form of a transparent window (56) but also has an operatively uppermost hollow transparent projection (57) extending generally radially from the peripheral wall. The transparent projection, being uppermost, will receive any initial leakage and will be highly visible in order to communicate the fact that leakage is occurring.

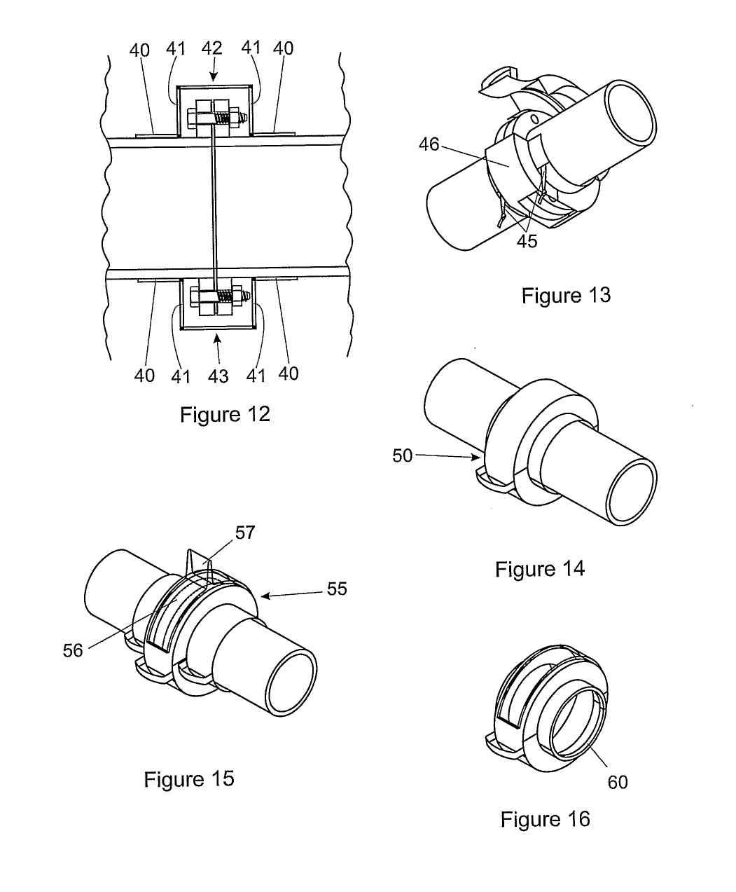

FIG. 16 illustrates a circumferentially extending sealing strip (60) extending in the circumferential direction around the edge region of the collar of a cover essentially as described with reference to FIGS. 11 to 12 of the accompanying drawings. Such a sealing strip can be employed to hermetically seal the interior of the cover, should this be required.

Numerous other variations may be made without departing from the scope hereof.

1. A cover for a pipe coupling wherein the cover has a first part in the form of an impervious collection chamber adapted to cover approximately one circumferential half of a pipe coupling, the collection chamber being defined by a pair of spaced generally parallel side walls and a peripheral wall interconnecting corresponding radially outer edges of the side walls to form the collection chamber with free edges of the walls forming an opening communicating with the collection chamber;
generally semi-circular recesses centrally located in the free edges of the side walls for accommodating one half of the circumference of a pipe adjacent a coupling in use;
a co-operant second part of the cover serving as a retainer for the first part, in use, and having side walls and at least one interconnecting peripheral wall with corresponding recesses in free edges of the side walls for accommodating an opposite half of the circumference of a pipe adjacent a coupling in use such that, in a closed position of the cover, a pipe coupling may be substantially enclosed within the cover,
wherein the side walls are made of a generally flexible sheet material and a laterally extending collar extends around the periphery of each of the recesses and means are provided for holding the collars around the outer surface of a pipe in use.

2. A cover as claimed in claim 1 in which the means for holding the collars around the outer surface of a pipe are extension flaps that can be partially overlapped with an adjacent collar of the other part of the cover and wherein means are provided for releasably securing each extension flap to the overlapped surface of the other part of the cover.

3. A cover as claimed in claim 2 in which a separate band is provided for engaging a collar and adjacent pipe surface with the separate band having a band extension for overlapping an adjacent zone of an adjacent collar.

4. A cover as claimed in claim 2 in which overlapping zones are connected by releasable fasteners.

5. A cover as claimed in claim 4 in which overlapping zones are connected by releasable hook and loop fasteners.

6. A cover as claimed in claim 2 in which overlapping extensions have suitable handgrips for manipulating them.

7. A cover as claimed in claim 1 in which the peripheral wall of the collection chamber and a peripheral wall of the co-operant second part are connected at one end thereof by way of a hinge zone.

8. A cover as claimed in claim 3 in which the separate bands are connected at one end thereof by way of a hinge zone to an associated collar.

9. A cover as claimed claim 1 in which at least a part of one of the walls defining the collection chamber is transparent.

10. A cover as claimed in claim 9 in which the transparent part forms a window in the peripheral wall of the collection chamber.

11. A cover as claimed in claim 10 in which the transparent part includes a hollow transparent projection extending generally radially from the peripheral wall.

12. A cover as claimed claim 1 in which the side walls, collars, and peripheral walls are made of polymer material wherein individual side walls, collars and peripheral walls are cut to a required shape and are fastened together by welding.

13. A cover as claimed claim 1 in which the cover is suitable for use in covering a pipe coupling that is elevated relative to the ground or other support surface and wherein the second part of the cover is substantially similar to the first part.

14. A cover as claimed in claim 13 in which the collars are provided with seals for sealing the interior of the cover.

15. A cover as claimed claim 1 in which the cover is suitable for use in covering a pipe coupling that actually rests on a support for the pipe, wherein the second part of the cover has a removable section and the lowermost part of the side walls and peripheral wall are cut away to provide an opening to accommodate the zone of a pipe coupling resting on the support therefor.
